(19) United States
(12) Patent Application Publication
(10) Pub. No.: US 2002/0103925 A1
(43) Pub. Date: Aug. 1, 2002

(54) Generic programmable internet protocol classification technique for a broadband engine

(76) Inventors: Siddharth C. Sheth, San Jose, CA (US); Allen P. Chen, San Jose, CA (US)

Correspondence Address: Edwin H. Taylor, Blakely, Sokoloff, Taylor & Zafman LLP, Seventh Floor, 12400 Wilshire Boulevard, Los Angeles, CA, 90025-1030, US

(21) Appl. No.: 09/732,329

(22) Filed: Dec. 6, 2000

(51) Int. Cl. G06F 15/16

(52) U.S. Cl. 709/236

(57) ABSTRACT

A method and an apparatus of utilizing a dynamically modifiable combination of fields in a header of an internet protocol version 4 (hereinafter IPv4) packet to classify the IPv4 packet are disclosed. In one embodiment, the apparatus includes a transceiver module and a lookup module. The lookup module is coupled to an external processor via an external processor interface, an external content adjustable memory and the transceiver module. The lookup module also contains a processing core that performs the IPv4 packet classification based on information from the external processor and information stored in the external content adjustable memory.

### FIELD OF THE INVENTION

This invention relates to internet technologies generally and particularly to internet protocol packet classification techniques and systems.

### BACKGROUND OF THE INVENTION

Historically, internet protocol (hereinafter IP) based networks have been able to provide a simple “best-effort” delivery service to all applications they carry. In particular, this service treats all packets equally, with no service levels, requirements, reservations, or guarantees. Although this indiscriminate treatment of packets introduces delay and variability in data transfer rate, the best-effort delivery scheme has still been able to satisfy a net user's typical needs, such as e-mail, file transfer or Web browsing. However, as demand for real-time, multimedia and multicasting applications grows, networks that only provide the aforementioned best-effort delivery service are no longer able to adequately support these delay-sensitive applications. For example, a slight congestion on such networks could transform an Internet phone call into gibberish.

The Integrated Services Architecture (ISA) is one prior-art solution that addresses the shortcomings of the best-effort delivery service. Specifically, ISA associates each IP packet with a flow, which is a distinguishable stream of related IP packets that results from a single user activity and requires the same quality of service (hereinafter QoS). Then ISA treats the IP packets of a particular flow identically for purposes of resource allocation and queuing discipline. Therefore, under ISA, packets for delay-sensitive applications such as an internet phone call would receive higher priority treatment than packets for non-delay-sensitive applications, such as email. This process of mapping packets into classes that may correspond to a single flow or a set of flows is also referred to as packet classification.

However, the existing IP packet classification techniques typically use specific fields in an IP packet header and does not provide any flexible means to alter the field designation. One such packet classification scheme is the differentiated services architecture, which supports a range of network services that are differentiated on the basis of performance.

FIG. 1 illustrates the datagram format of an internet protocol version 4 (hereinafter IPv4) packet. Specifically, IPv4 packet 100 contains version field 102 (4 bits), Internet Header Length (IHL) field 104 (4 bits), type of service field 106 (8 bits), total length field 108 (16 bits), identification field 110 (16 bits), flags field 112 (3 bits), fragment offset field 114 (13 bits), time to live field 116 (8 bits), protocol field 118 (8 bits), header checksum field 120 (16 bits), source address field 122 (32 bits), destination address field 124 (32 bits), options/padding field 126 (variable) and data field 128 (a variable integer multiple of 8 bits). The differentiated services architecture labels IPv4 packets using type of service field 106 for differing QoS treatment. If a network operator opts to implement the differentiated services architecture in its network, it then configures its routers with appropriate forwarding policies based on the value in service field 106. Once the network is in its normal operating state, the network operator would most likely unable to switch to a different packet classification scheme that uses fields other than type of service field 106.

Thus, an apparatus and method is needed to provide a flexible, programmable and highly scaleable solution to continue improving packet delivery mechanisms and more specifically to further advance packet classification technology and its deployment in network systems.

### BRIEF DESCRIPTION OF THE DRAWINGS

The present invention is illustrated by way of example and is not limited by the figures of the accompanying drawings, in which like references indicate similar elements, and in which:

FIG. 1(a) illustrates the datagram format of an internet protocol version 4 packet.

FIG. 2 illustrates a block diagram of one embodiment of the present invention, broadband engine.

FIG. 3 illustrates a block diagram of a line card that one embodiment of the present invention resides in.

FIG. 4 illustrates a block diagram of a communication system that one embodiment of the present invention resides in.

FIG. 5 illustrates a one process that one embodiment of the present invention follows to generically classify internet protocol version 4 packets.

### DETAILED DESCRIPTION

An apparatus and method for utilizing a dynamically modifiable combination of fields of an internet protocol version 4 (hereinafter IPv4) packet header to classify the packet are described. In the following description, numerous specific details are set forth in order to provide a thorough understanding of the present invention. However, it will be apparent to one of ordinary skill in the art that the invention may be practiced without these particular details. In other instances, well known elements and theories such as Synchronous Optical Network (hereinafter SONET), Packet over SONET (hereinafter POS), Universal Test and Operational Physical Interfaces for Asynchronous Transfer Mode (UTOPIA) bus, Peripheral Component Interconnect (hereinafter PCI), packet framing, routing protocols, routing tables, etc. have not been described in special detail in order to avoid obscuring the present invention.

Moreover, throughout this disclosure, the term “generic packet classification” broadly refers to a protocol independent technique that selects a class based on any allowable field in IPv4 packet header and maps a packet into the selected class. A class may correspond to a single flow or to a set of flows with the same quality of service (hereinafter QoS) requirements. Also, this technique provides a mechanism to dynamically modify the class information and the fields in IPv4 packet header used to convey such information. In other words, during normal operations of a network stack, this technique allows a change from a first classification using a first combination of fields in IPv4 packet header to a second classification using a second combination of fields.

Additionally, in subsequent discussions, content addressable memory (hereinafter CAM) refers to a programmable memory device that provides search capability to its content. One example of CAM is the NL887314 from Netlogic Microsystems™. The disclosure also uses SONET, which refers to a high-speed time division-multiplexing physical-layer transport technology, and POS, which provides a method for efficiently carrying data packets in SONET frames, to describe the operations of the present invention. Finally, a machine readable medium refers to, but not limited to, a storage device, a memory device, a carrier wave, etc.

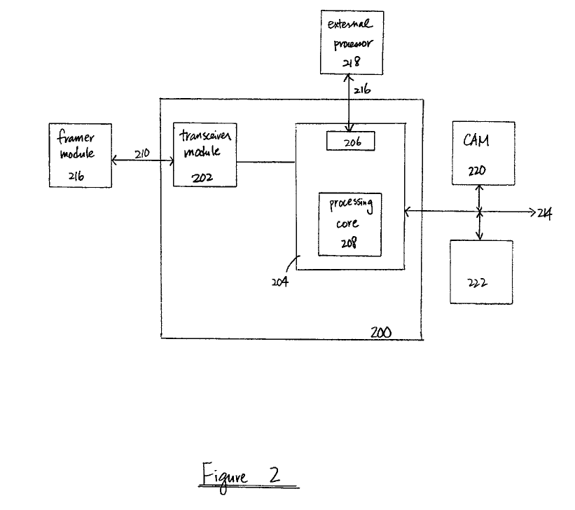

FIG. 2 illustrates a block diagram of one embodiment of the present invention, broadband engine 200. Specifically, one implementation of broadband engine 200 includes transceiver module 202 and lookup module 204. Transceiver module 202 is responsible for bridging the communication between framer module 216 and lookup module 204. For example, framer module 216 provides transceiver module 202 with packets that operate in POS mode via bus 210 (in this example, bus 210 is UTOPIA bus). After having received these POS packets, one embodiment of transceiver module 202 appends some control information to certain portion of the packets before relaying the packets to lookup module 204.

One embodiment of lookup module 204 comprises external processor interface 206 and processing core 208. External processor interface 206 allows external processor 218 to communicate information via bus 212 to processing core 208 and also to program information in CAM 220. After having identified an IPv4 packet out of the packets received from transceiver module 202, based on the information from external processor 218 and the information stored in CAM 220, processing core 208 generically classifies the IPv4 packet. Examples will be provided in the subsequent section that discusses the operations of broadband engine 200 to further explain the generic IPv4 packet classification technique.

External processor 218 typically performs functions such as, but not limited to, running routing protocols, building routing tables, providing general system maintenance capabilities, etc. in a communication system. It is important to note that external processor 218 may physically reside either on the same or a different line card with broadband engine 200 and yet still remain within the scope of the present invention. Additionally, it should be apparent to one with ordinary skill in the art to recognize that broadband engine 200 in general and its components (such as transceiver module 202 and lookup module 204) in particular are capable of performing functions other than the mentioned packet classification technique.

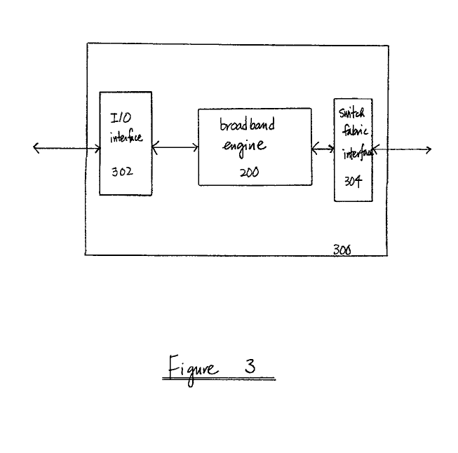

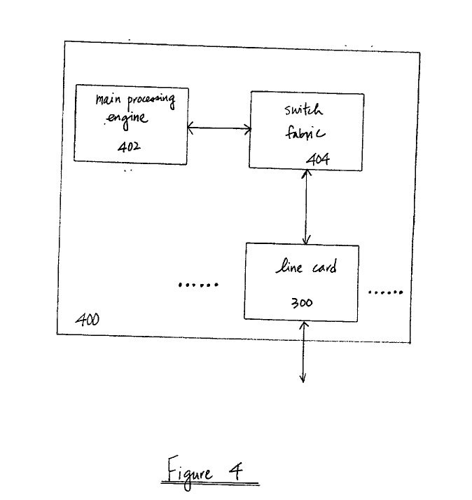

Broadband engine 200 can be implemented with one or more Application Specific Integrated Circuit (ASIC) and be incorporated into a number of systems, such as line card 300 as shown in FIG. 3. Line card 300 can further be part of communication system 400 as shown in FIG. 4. Specifically, input/output interface 302 of line card 300 is responsible for translating between signals that travel on physical cabling coupled to line card 300 and packets that are recognizable by broadband engine 200. Switch fabric interface 304, on the other hand, provides broadband engine 200 a pathway to switch fabric 404 as shown in FIG. 4. Switch fabric generally constitutes the totality of possible data paths that can be established throughout communication system 400. In other words, if communication system 400 has more than one line card, all the line cards can then communicate with one another by means of switch fabric 404.

In one communication system 400 that the present invention resides in, external processor 218 as shown in FIG. 2 resides in main processing engine 400, and framer module 216 resides in input/output interface 302 of line card 300. It should however be apparent to an ordinarily skilled artisan to incorporate broadband engine 200 in systems that are different than the ones shown in FIGS. 3 and 4 without exceeding the scope of the present invention.

### Operation of One Embodiment of Broadband Engine

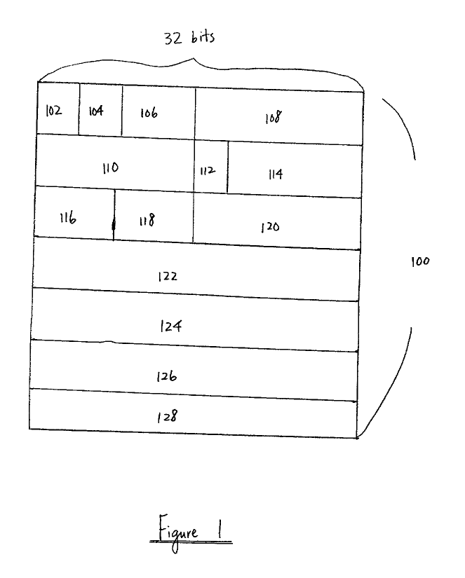

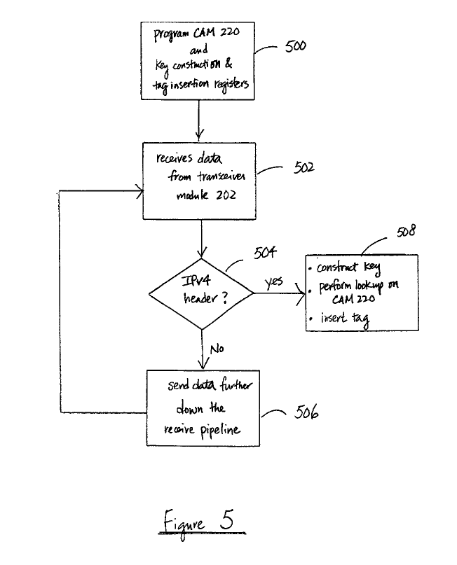

In conjunction with FIG. 2, FIG. 5 illustrates one process that one embodiment of broadband engine 200 follows to generically classify IPv4 packets. Specifically, in block 500, external processor 218 accesses CAM 220 through external processor interface 206 and programs CAM 220 with tag values and their corresponding keys. External processor 218 typically retrieves this tag-key information from its own memory device (not shown in FIG. 2 to avoid obscuring the present invention). The key value serves as an identifier for processing core 208 to search through a table of tag-key entries in CAM 220. The tag information, on the other hand, pertains to packet classification information and is inserted in one of the fields of an IPv4 packet header as shown in FIG. 1. In addition, the programming of tag-key information in CAM 220 typically occurs at the initialization stage but can also occur during the steady state of the system that broadband engine 200 resides on. Communication system 400 as shown in FIG. 4 is one example of such a system.

Furthermore, one embodiment of external processor interface 206 includes registers that are accessible to external processor 218. In block 500, external processor 218 also programs these registers, or key construction and tag insertion registers, with relevant information. In one particular implementation, the key construction register contains information with the following format:

| | | |
|---|---|---|
| Bits 15:7 | Bit 6 (valid bit) | Bits 5:0 |

| | |
|---|---|
| First 9 bit value of | First 6 bit value |
| bit-offset from start of IPv4 | indicating number of |
| packet header | bits to be read |
| Second 9 bit value of | Second 6 bit value |
| bit-offset from start of IPv4 | indicating number of |
| packet header | bits to be read |
| Third 9 bit value of | Third 6 bit value |
| bit-offset from start of IPv4 | indicating number of |
| packet header | bits to be read |
| Fourth 9 bit value of | Fourth 6 bit value |
| bit-offset from start of IPv4 | indicating number of |
| packet header | bits to be read |

In other words, this implementation of key construction register has capacity for 4 16-bit data chunks relevant to establish key values. The first 9 bits of a 16-bit data chunk encodes a bit-offset from the beginning of an IPv4 packet header, whereas the last 6 bits encodes the number of bits to read from that bit-offset. The bit-offset is also referred to as a “retrieval location” in this disclosure. External processor 218 may program the key construction register either during initialization or during normal operations. If programming occurs during normal operations and some of the 16-bit data chunks become inapplicable as a result, external processor 218 can mark bit 6, or the valid bit, of the affected data chunks to alert processing core 208 not to process them further.

One implementation of tag insertion register contains data that follow the format demonstrated below:

| Bits 15:9 | Bits 8:0 |
|---|---|
| Number of bits to read from | Bit-offset indicating where to insert |
| the retrieved tag | the tag in an IPv4 packet header |

The bit-offset that is represented by the last 9 bits is also referred to as a “insertion location” in this disclosure.

For illustration purposes, assuming bus 210 is UTOPIA bus and framer module 216 provides broadband engine 200 packets that operate in POS mode, one embodiment of transceiver module 202 collects the first 48 bytes of each packet, appends a 64-bit long POS header to the 48 bytes and passes the combined 56 bytes to lookup module 204 in block 502. If the 48 bytes are the beginning portion of a packet, transceiver module 202 sets bit 60 of the 64-bit POS header to ‘1’ to inform lookup module 204. However, it should be apparent to an ordinarily skilled artisan to apply mechanisms other than this discussed method of passing control information between components of broadband engine 200 without exceeding the scope of the present invention.

In block 504, lookup module 204 proceeds to examine the data from transceiver module 202. If lookup module 204 does not detect the requisite fields that constitute an IPv4 packet header and establishes that the 48-byte data represent payload data, lookup module 204 sends the data further down its receive pipeline in block 508. Otherwise, lookup module 204 performs generic IPv4 packet classification in block 506.

More particularly, in conjunction with FIGS. 2 and 4 and for illustration purposes, a processor in main processing engine 402 first programs CAM 220, the key construction and tag insertion registers with appropriate information representative of a first type of packet classification during the initialization of communication system 400. This first packet classification uses one field, or type of service field 106, to indicate different QoS treatment. Then assuming that main processing engine 402 decides to switch to a second type of packet classification, which utilizes both type of service field 106 and option/padding field 126, while in its steady state, processor of main processing engine 402 reprograms CAM 220, the key construction and tag insertion registers with a different set of information. Assuming further that the first type of classification and the second type of classification both read 8 bits from type of service field 106 and the second classification reads 10 bits from option/padding field 126, the reprogrammed key construction register should have the following two 16-bit data chunks:

| Bits 15:7 | Bit 6 (valid bit) | Bits 5:0 |
|---|---|---|
| 000010000 | 1 | 001000 |
| 010100000 | 1 | 001010 |

The first 9 bits of the two data chunks reflect that type of service field 106 begins 16 bits from the start of an IPv4 packet header and option/padding field 126 begins 160 bits from the start, respectively. The valid bit of the first 16-bit data chunk remains at 1, because both classification schemes read the same number of bits from the same field as having been assumed above.

Based on the two data chunks, broadband engine 200 retrieves information from the IPv4 packet, or a key value, and proceeds to look up entries in CAM 220 that matches the key value. After an entry is identified, its corresponding tag information is then retrieved and inserted in the IPv4 packet in a fashion consistent with the content of the tag insertion register. Assuming that the second classification specifies that 3 bits from the retrieved tag is to be inserted in data field 128, the reprogrammed tag insertion register should contain the following 16-bit data chunk:

| Bits 15:9 | Bits 8:0 |
|---|---|
| 0000011 | 011000000 |

Thus, a method and an apparatus for utilizing a dynamically modifiable combination of fields of an internet protocol version 4 packet header to classify the packet have been described. Although a broadband engine card has been described particularly with reference to the figures, it will be apparent to one of the ordinary skill in the art that the present invention may appear in any of a number of other communication systems. It is contemplated that many changes and modifications may be made by one of ordinary skill in the art without departing from the spirit and scope of the present invention.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Sanjeet Dutta, Reg. No. 46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Joseph Lutz, Reg. No. 43,765; Michael J. Mallie, Reg. No. 36,591; Andre L. Marais, under 37 C.F.R. § 10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey Sam Smith, Reg. No. 39,377; Maria McCormack Sobrino, Reg. No. 31,639; Stanley W. Sokoloff, Reg. No. 25,128; Judith A. Szepesi, Reg. No. 39,393; Vincent P. Tassinari, Reg. No. 42,179; Edwin H. Taylor, Reg. No. 25,129; John F. Travis, Reg. No. 43,203; Joseph A. Twarowski, Reg. No. 42,191; Tom Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; Justin M. Dillon, Reg. No. 42,486; Thomas S. Ferrill, Reg. No. 42,532; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Edward R. Brake, Reg. No. 37,784; Ben Burge, Reg. No. 42,372; Jeffrey S. Draeger, Reg. No. 41,000; Cynthia Thomas Faatz, Reg No. 39,973; John N. Greaves, Reg. No. 40,362; Seth Z. Kalson, Reg. No. 40,670; David J. Kaplan, Reg. No. 41,105; Peter Lam, Reg. No. 44,855; Charles A. Mirho, Reg. No. 41,199; Leo V. Novakoski, Reg. No. 37,198; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Gene I. Su, Reg. No. 45,140; Calvin E. Wells, Reg. No. P43,256, Raymond J. Werner, Reg. No. 34,752; Robert G. Winkle, Reg. No. 37,474; Steven D. Yates, Reg. No. 42,242; and Charles K. Young, Reg. No. 39,435; my patent attorneys, of INTEL CORPORATION; and James R. Thein, Reg. No. 31,710, my patent attorney with full power of substitution and revocation, to prosecute this application and to transact all business in the Patent and Trademark Office connected herewith.

### APPENDIX B

### Title 37, Code of Federal Regulations, Section 1.56

### Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclosure information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclosure all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made or record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

What is claimed is:

1. A method, comprising:
identifying a combination of fields in a header of an internet protocol version 4 (hereinafter IPv4) packet, wherein the combination is dynamically modifiable; and
utilizing the combination of fields to classify the IPv4 packet.

2. The method according to claim 1, further comprising:
a. constructing a key according to information in a key construction register;
b. identifying a tag that corresponds to the key from a table of key-tag entries in a memory device; and
c. inserting the tag in the header of IPv4 packet in accordance to information in a tag insertion register.

3. The method according to claim 2, wherein the information in the key construction register indicates a retrieval location in the header of IPv4 packet and a number of bits from the retrieval location to consider in constructing the key.

4. The method according to claim 2, wherein the information in the tag insertion register indicates a number of bits to retrieve from the tag and an insertion location in the header of IPv4 packet to insert the tag.

5. A broadband engine, comprising:
a. a transceiver module; and
b. a lookup module, coupled to an external processor via an external processor interface, an external content adjustable memory and the transceiver module, further including:
a processing core to classify an internet protocol version 4 (hereinafter IPv4) packet by utilizing a dynamically modifiable combination of fields in a header of the IPv4 packet.

6. The broadband engine according to claim 5, the transceiver module further
a. collects a portion of incoming packets; and
b. appends control information to the collected portion.

7. The broadband engine according to claim 5, the lookup module further comprising:
a. a plurality of registers to contain key construction information and tag insertion information from the external central processing unit; and
b. the processing core to construct a key according to the key construction information, retrieve a tag that corresponds to the key from the external content adjustable memory and insert the tag in a header of one of the packets based on the tag insertion information.

8. The broadband engine according to claim 7, wherein the key construction information further comprises:
a retrieval location in the header of IPv4 packet and a number of bits from the retrieval location to consider in constructing the key.

9. The broadband engine according to claim 7, wherein the tag insertion information further comprises:
a number of bits to retrieve from the tag and an insertion location in the header of IPv4 packet to insert the tag.

10. A line card, comprising:
an input/output interface;
a switch fabric interface to communicate with a switch fabric; and
a broadband engine, coupled to the input/output interface and the switch fabric interface, further including:
a. a transceiver module to receive a plurality of packets from the input/output interface; and
b. a lookup module, coupled to an external content adjustable memory, the transceiver module and an external processor, further including:
a processing core to classify an internet protocol version 4 (hereinafter IPv4) packet by utilizing a dynamically modifiable combination of fields in a header of the IPv4 packet.

11. The line card according to claim 10, the transceiver module further
a. collects a portion of incoming packets; and
b. appends control information to the collected portion.

12. The line card according to claim 10, the lookup module further comprising:
a. a plurality of registers to contain key construction information and tag insertion information from the external central processing unit; and
b. the processing core to construct a key according to the key construction information, retrieve a tag that corresponds to the key from the external content adjustable memory and insert the tag in a header of one of the packets based on the tag insertion information.

13. The line card according to claim 12, wherein the key construction information further comprises:
a retrieval location in the header of IPv4 packet and a number of bits from the retrieval location to consider in constructing the key.

14. The line card according to claim 12, wherein the tag insertion information further comprises:
a number of bits to retrieve from the tag and an insertion location in the header of IPv4 packet to insert the tag.

15. A communication system, comprising:
a. a switch fabric;
b. a main processing engine with an processor; and
c. a line card, coupled to t he switch fabric via a switch fabric interface, further including:
an input/output interface;
a broadband engine, coupled to the input/output interface and the switch fabric interface, further comprising:
i. a transceiver module to receive a plurality of packets from the input/output interface; and
ii. a lookup module, coupled to an external content adjustable memory, the transceiver module and the processor, further including:
a processing core to classify an internet protocol version 4 (hereinafter IPv4) packet by utilizing a dynamically modifiable combination of fields in a header of the IPv4 packet.

16. The communication system according to claim 15, the transceiver module further
a. collects a portion of incoming packets; and
b. appends control information to the collected portion.

17. The communication system according to claim 15, the lookup module further comprising:
a. a plurality of registers to contain key construction information and tag insertion information from the external central processing unit; and
b. the processing core to construct a key according to the key construction information, retrieve a tag that corresponds to the key from the external content adjustable memory and insert the tag in a header of one of the packets based on the tag insertion information.

18. The communication system according to claim 17, wherein the key construction information further comprises:
a retrieval location in the header of IPv4 packet and a number of bits from the retrieval location to consider in constructing the key.

19. The communication system according to claim 17, wherein the tag insertion information further comprises:
a number of bits to retrieve from the tag and an insertion location in the header of IPv4 packet to insert the tag.
